(19) United States
(12) Patent Application Publication
(10) Pub. No.: US 2026/0285417 A1
(43) Pub. Date: Sep. 24, 2026

(54) AIR CURTAIN DEVICE

(71) Applicant: HYUNDAI MOBIS CO., LTD., Seoul (KR)

(72) Inventors: Jang Ho KIM, Yongin-si (KR); Jae Sup BYUN, Yongin-si (KR)

(73) Assignee: HYUNDAI MOBIS CO., LTD., Seoul (KR)

(21) Appl. No.: 19/087,205

(22) Filed: Mar. 21, 2025

(51) Int. Cl. B62D 35/00

(52) U.S. Cl. CPC B62D 35/005

(57) ABSTRACT

The present disclosure relates to an improved air curtain device that does not deteriorate the aesthetics of a vehicle. An air curtain device disposed in front of a wheel of a vehicle includes a housing formed with an inflow region that allows a driving wind to pass therethrough, an air curtain rotatably disposed in the housing, an actuator that is coupled to the housing and generates power that rotates the air curtain, and a link assembly that is connected to the housing, the air curtain, and the actuator, and pulls the air curtain toward the actuator so that the air curtain exposes the inflow region formed in the housing.

### BACKGROUND

### 1. Field of the Disclosure

The present disclosure relates to an air curtain device and a bumper assembly for a vehicle including the same.

### 2. Discussion of Related Art

An air curtain device is a device capable of enhancing the aerodynamics of a vehicle, and can be disposed at the front of the vehicle to guide a driving wind, which is generated when the vehicle is driven, toward the wheels.

The air curtain device may include an air curtain which covers an inlet hole formed in a bumper or front fender, which is a component at the front of the vehicle, an actuator which generates power to rotate the air curtain, and a link which connects the air curtain and the actuator and pushes or pulls the air curtain through the power generated by the actuator.

In the conventional air curtain device, since the air curtain is disposed on the same line as the bumper or front fender, and is rotated in a direction from a lower side toward an upper side of the vehicle, an image of the front of the vehicle before and after the operation of the air curtain may significantly change. This may act as a factor that deteriorates the aesthetics of the vehicle.

### SUMMARY

The present disclosure is to solve the above problems, and one embodiment of the present disclosure is directed to providing an improved air curtain device that does not deteriorate the aesthetics of a vehicle.

An air curtain device disposed in front of a wheel of a vehicle according to one embodiment of the present disclosure includes a housing including an inflow region that allows a driving wind to pass therethrough; an air curtain rotatably disposed in the housing; an actuator that is coupled to the housing and generates power that rotates the air curtain; and a link assembly that is connected to the housing, the air curtain, and the actuator, and pulls the air curtain toward the actuator so that the air curtain exposes the inflow region of the housing.

The link assembly may include a power transmission link connected to the actuator, and the power transmission link may rotate in a direction opposite to a rotating direction of the air curtain.

The link assembly may include a curtain link that connects the housing and the air curtain; a first connecting link rotatably coupled to the power transmission link; and a second connecting link fixed to the curtain link to connect the first connecting link and the curtain link.

The first connecting link may be disposed parallel to the power transmission link when the air curtain closes the inflow region of the housing.

The link assembly may include an axial link that is coupled to the air curtain and serves as a center of rotation of the air curtain, and the housing may include a rotation receiving portion that rotatably receives the axial link therein.

The axial link may cover an open region of the rotation receiving portion of the housing.

A radius of rotation of the curtain link and a radius of rotation of the axial link may be different.

The axial link may be disposed at an end portion of the air curtain.

### BRIEF DESCRIPTION OF THE DRAWINGS

The following drawings attached to this specification illustrate preferred embodiments of the present disclosure and, together with the detailed description of the disclosure to be described below, serve to further understand the technical idea of the present disclosure, and therefore the present disclosure should not be construed as being limited to matters described in such drawings, in which:

FIG. 1A is a view showing a state in which an air curtain device according to one embodiment of the present disclosure closed the front fender of a vehicle;

FIG. 1B is a view showing a state in which an air curtain device according to one embodiment of the present disclosure opened the front fender of a vehicle;

FIG. 2 is a perspective view of an air curtain device;

FIG. 3 is an exploded perspective view of the air curtain device;

FIG. 4 is a front perspective view of a housing;

FIG. 5 is a rear perspective view of the housing;

FIG. 6 is a view showing an unexposed region of an air curtain;

FIG. 7 is a perspective view of a link assembly;

FIG. 8 is an exploded perspective view of the link assembly excluding an axial link;

FIG. 9A is a view showing a state in which an actuator is disposed in the housing;

FIG. 9B is a view showing a state in which a power transmission link is coupled to the actuator coupled to the housing;

FIG. 10 is a view showing a state in which a first connecting link is coupled to the power transmission link;

FIG. 11 is a view showing a state in which a second connecting link is coupled to the first connecting link;

FIG. 12 is a view showing a state in which a curtain link is coupled to the housing;

FIG. 13 is a view showing a state in which the housing and the air curtain are coupled to the power transmission link;

FIG. 14 is a view showing a state in which the axial link is disposed in a rotation receiving portion of the housing;

FIG. 15A is a view showing a state before the air curtain is rotated;

FIG. 15B is a view showing a state after the air curtain is rotated;

FIGS. 16A and 16B is a view showing a state in which a portion of the air curtain has moved; and

FIG. 17 is a view showing a state in which a covering portion of the axial link covers a portion of the rotation receiving portion of the housing.

### DETAILED DESCRIPTION OF EXEMPLARY EMBODIMENTS

Since the present disclosure may be subjected to various changes and have various embodiments, specific embodiments will be exemplified and described in the drawings. However, it should be understood that this is not intended to limit the present disclosure to specific embodiments, and includes all changes, equivalents, and substitutes included in the spirit and scope of the present disclosure.

Terms including ordinal numbers, such as first, second, and the like, may be used to describe various components, but the components are not limited by the terms. The terms are used only for the purpose of distinguishing one component from other components. For example, without departing from the scope of the present disclosure, a second component may be referred to as a first component, and similarly, a first component may also be referred to as a second component. The term ‘and/or’ includes a combination of a plurality of related listed items or any one item of the plurality of related listed items.

When a certain component is mentioned as being “connected” or “linked” to another component, it should be understood that the certain component may be directly connected or linked to the other component, but still another component may be present therebetween. On the other hand, when it is mentioned that the certain component is “directly connected” or “directly linked” to another element, it should be understood that there is no other component therebetween.

When one component is described as being formed “on or under” another component, “on or under” includes both a case in which the two components are in direct contact with each other and a case in which at least another component is disposed between the two components (indirectly). Further, when “on or under” is expressed, a meaning of not only an upward direction but also a downward direction may be included based on one component.

The terms used in the present application is only used to describe specific embodiments and are not intended to limit the present disclosure. Further, a singular form includes a plural form unless the context clearly dictates otherwise. In the present application, it should be understood that terms such as “include” or “have” are intended to indicate the presence of a feature, number, step, operation, component, part, or a combination thereof described in the specification, and they do not exclude in advance the possibility of the presence or addition of one or more other features or numbers, steps, operations, components, parts or combinations thereof.

Unless otherwise defined, all terms used herein, including technical or scientific terms, have the same meaning as terms generally understood by those skilled in the art. Terms such as terms defined in generally used dictionaries should be interpreted as terms having meanings consistent with the meanings in the context of the related art, and should not be interpreted in an idealistic or excessively formal sense unless explicitly defined in the present application.

Hereinafter, an air curtain device is described in detail with reference to the accompanying drawings, and the same reference numerals denote the same or similar components regardless of the reference numerals, and overlapping descriptions thereof will be omitted.

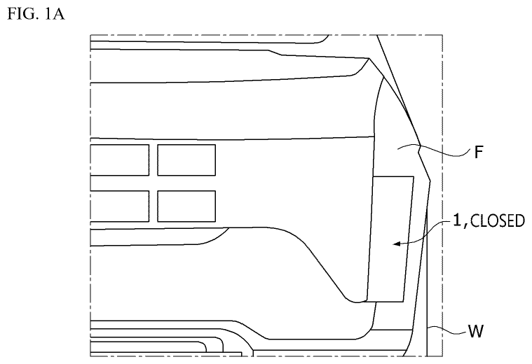

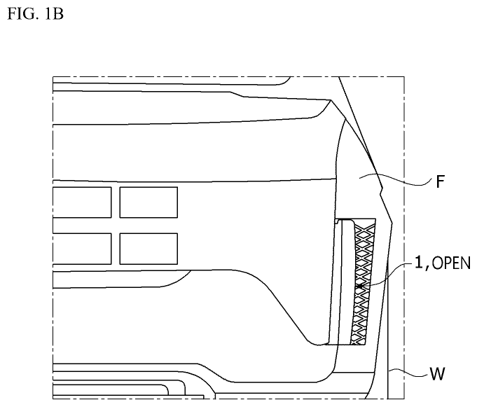

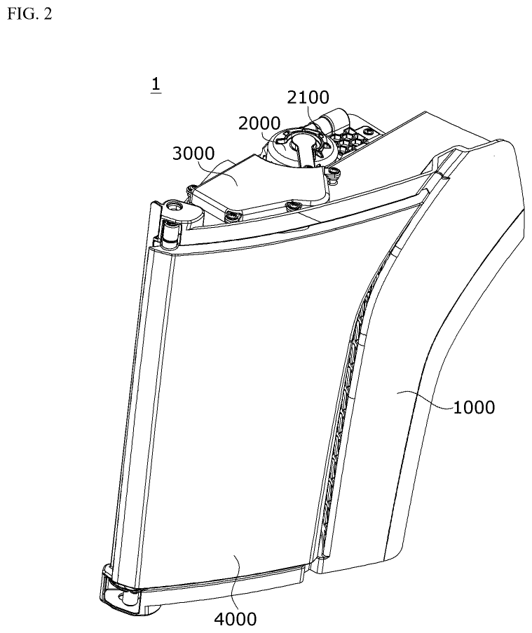

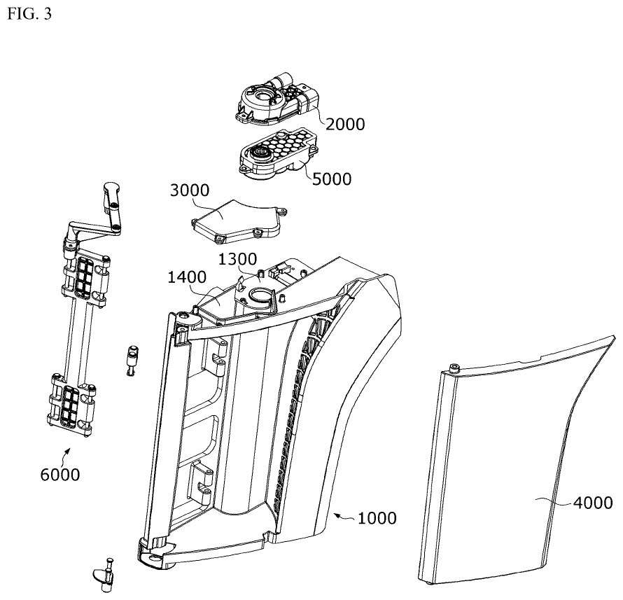

FIG. 1A is a view showing a state in which an air curtain device according to one embodiment of the present disclosure closed the front fender of a vehicle, FIG. 1B is a view showing a state in which an air curtain device according to one embodiment of the present disclosure opened the front fender of a vehicle, FIG. 2 is a perspective view of an air curtain device, and FIG. 3 is an exploded perspective view of the air curtain device.

Referring to FIGS. 1 to 3, an air curtain device 1 according to one embodiment of the present disclosure may be disposed in front of a wheel W of a vehicle. More specifically, the air curtain device 1 may be disposed on a front fender F disposed at both sides of a bumper of the vehicle along a width direction. Accordingly, the air curtain device 1 may serve to introduce a driving wind, which is generated when the vehicle is driven, into the front fender F or block the driving wind. Here, the width direction in the embodiment may mean a direction from a driver's seat to a passenger's seat of the vehicle or a direction opposite thereto. The air curtain device 1 may include a housing 1000, a first cover 2000, a second cover 3000, an air curtain 4000, an actuator 5000, and a link assembly 6000. In the embodiment, an example in which the air curtain device 1 is disposed on the front fender F is described, but is not limited thereto. The air curtain device 1 may also be disposed on the bumper of the vehicle.

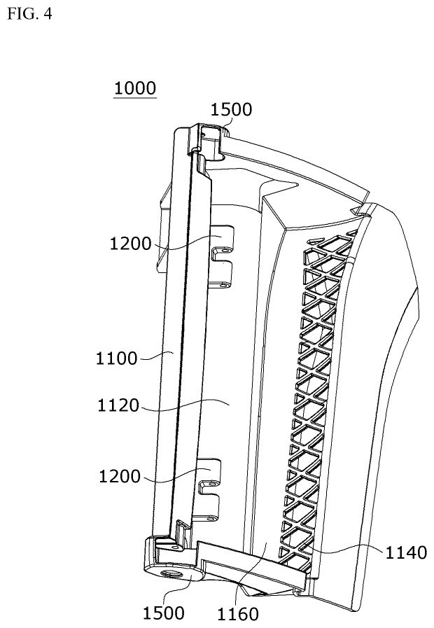

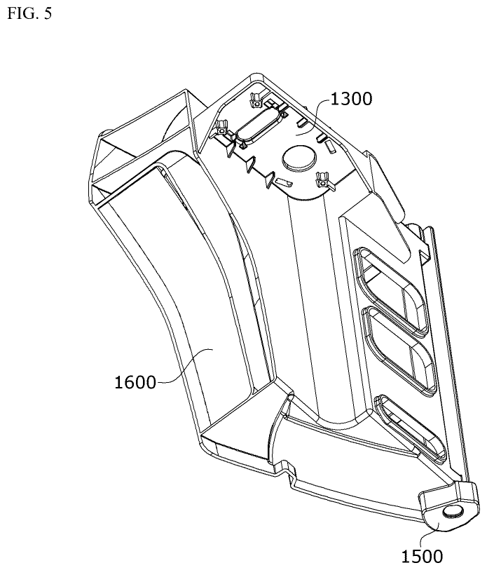

FIG. 4 is a front perspective view of the housing, and FIG. 5 is a rear perspective view of the housing.

Referring to FIGS. 1 to 5, the housing 1000 may support the first cover 2000, the second cover 3000, the air curtain 4000, and the actuator 5000, and may be coupled to the link assembly 6000 to support the link assembly 6000. Further, the housing 1000 may guide the driving wind so that the driving wind heads toward the wheel W of the vehicle or block movement of the driving wind so that the driving wind does not head toward the wheel W. The housing 1000 may include a first main portion 1100, a first support 1200, a second support 1300, a third support 1400, a rotation receiving portion 1500, and a guide portion 1600.

The first main portion 1100 may have a hollow shape with an empty interior. Accordingly, the first main portion 1100 may accommodate the link assembly 6000 therein and provide a rotation space 1120 in which the air curtain 4000 rotates.

An inflow region 1140 and a non-inflow region 1160 may be formed in the first main portion 1100. The inflow region 1140 may be a region composed of a hole formed in a portion of the first main portion 1100 and a plurality of ribs disposed in the hole. Accordingly, when the driving wind is introduced into the first main portion 1100 by the air curtain 4000, the inflow region 1140 may allow the driving wind introduced into the first main portion 1100 to pass therethrough. The driving wind passing through the inflow region 1140 heads toward the guide portion 1600.

Further, as a portion disposed on one side of the inflow region 1140 among the first main portion 1100, the non-inflow region 1160 is always covered by the air curtain 4000, and may be a region where a portion of the air curtain 4000 is disposed when the air curtain 4000 is rotated to open the inflow region 1140. Further, since a hole is not formed in the non-inflow region 1160, even when a phenomenon in that the driving wind leaks through a gap between the air curtain 4000 and the first main portion 1100 occurs, the driving wind may not pass to the outside of the first main portion 1100 through the non-inflow region 1160.

The first support 1200 may be disposed in an unexposed region, which is not exposed to the outside, of the first main portion 1100. The first support 1200 may protrude from the first main portion 1100. A plurality of first supports 1200 may be provided, and the plurality of first supports 1200 may be disposed along a height direction. Here, the height direction in the embodiment may mean a direction that is perpendicular to the width direction. The first support 1200 may be coupled to a curtain link 6400 to be described below of the link assembly 6000 to rotatably support the curtain link 6400.

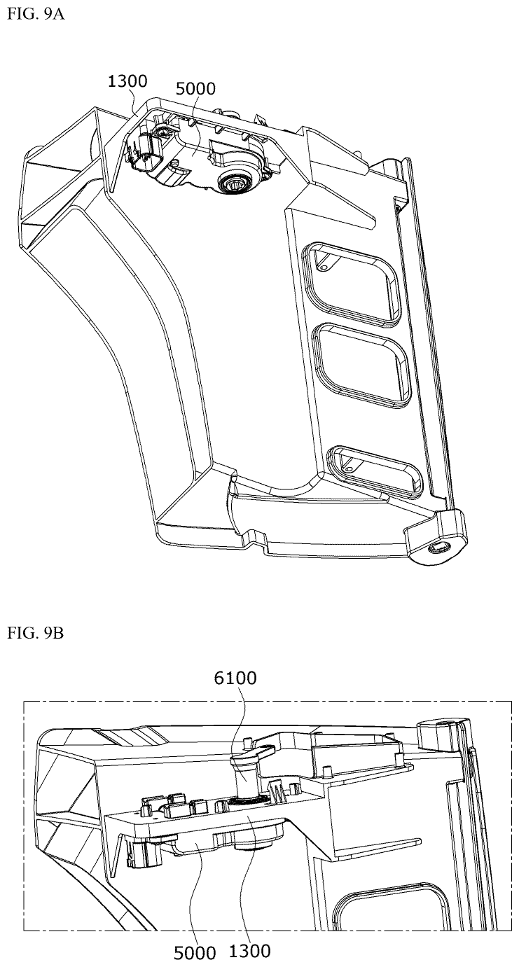

The second support 1300 may be disposed on the first main portion 1100. The second support 1300 protrudes from the first main portion 1100 and may be coupled to the actuator 5000 to support the actuator 5000 as shown in FIGS. 9A and 9B to be described below. Further, a hole through which a power transmission link 6100 to be described below passes may be formed in the second support 1300. Further, the second support 1300 may be coupled to the first cover 2000 to support the first cover 2000.

The third support 1400 may be disposed on the first main portion 1100. As shown in FIGS. 2 and 3, the third support 1400 protrudes from the first main portion 1100 and may be connected to the second support 1300. The third support 1400 may be coupled to the second cover 3000 to support the second cover 3000.

The rotation receiving portion 1500 may be disposed on the first main portion 1100. The rotation receiving portion 1500 may protrude from the first main portion 1100. A plurality of rotation receiving portions 1500 may be provided, and the plurality of rotation receiving portions 1500 may be disposed spaced apart from each other along the height direction. The rotation receiving portion 1500 may have a hollow shape with an empty interior. Accordingly, the rotation receiving portion 1500 may rotatably receive an axial link 6500 to be described below of the link assembly 6000 therein. Further, a groove may be formed in the outer surface of the rotation receiving portion 1500 for smooth entry of the axle link 6500.

The guide portion 1600 may be disposed on the first main portion 1100 and may protrude from the first main portion 1100. The guide portion 1600 may be connected to the inflow region formed in the first main portion 1100 to guide the driving wind passing through the inflow region toward the front fender F of the vehicle.

Referring to FIGS. 2 and 3, the first cover 2000 may be disposed on the second support 1300 of the housing 1000. The first cover 2000 may be disposed on a surface of the second support 1300 which is opposite to a surface where the actuator 5000 is disposed along the height direction. The first cover 2000 may have a hollow shape with an empty interior to accommodate the power transmission link 6100 to be described below, which is disposed on the second support 1300. A stopper 2100 may be formed on the first cover 2000. The stopper 2100 is a rib disposed on an outer surface of the first cover 2000, and may limit a rotational distance of the power transmission link 6100 to be described below.

The second cover 3000 may be disposed on the second support 1300 of the housing 1000. The second cover 3000 may cover the second support 1300 of the housing 1000. Further, the second cover 3000 may cover a part of the link assembly 6000 disposed on the second support 1300 of the housing 1000. Accordingly, the second cover 3000 may prevent damage to a part of the link assembly 6000 which may be caused by shaking due to vibration of the vehicle.

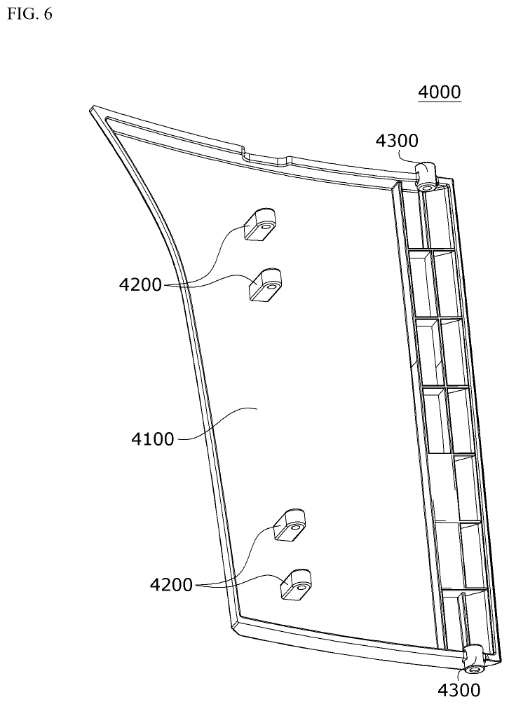

FIG. 6 is a view showing an unexposed region of the air curtain.

Referring to FIGS. 1, 2, and 6, the air curtain 4000 may be rotatably disposed in the housing 1000. The air curtain 4000 may include a second main portion 4100, a first coupling portion 4200, and a second coupling portion 4300.

The second main portion 4100 may form an exterior of the air curtain 4000. The second main portion 4100 may be disposed in the first main portion 1100 of the housing 1000. Specifically, the second main portion 4100 may be rotated in the rotation space 1120 formed in the first main portion 1100 of the housing 1000. The second main portion 4100 may be disposed in each of the inflow region 1140 and the non-flow region 1160 formed in the housing 1000 while being rotated in the rotation space 1120.

The first coupling portion 4200 may be formed in the unexposed region of the first coupling portion 4200, which is not exposed to the outside of the vehicle. A plurality of first coupling portions 4200 may be provided, and the plurality of first coupling portions 4200 may be disposed spaced apart from each other along the height direction. In this case, when the second main portion 4100 is disposed in the first main portion 1100 of the housing 1000, the first coupling portion 4200 may be disposed at a position facing a position where the first support 1200 disposed on the first main portion 1100 of the housing 1000 is disposed. The first coupling portion 4200 may be rotatably coupled to the curtain link 6400 to be described below of the link assembly 6000 and supported by the curtain link 6400.

A plurality of second coupling portions 4300 may be provided. The second coupling portions 4300 may be disposed on both end portions of the second main portion 4100 in the height direction. The plurality of second coupling portions 4300 may be disposed spaced apart from each other along the height direction. The second coupling portions 4300 may protrude from the second main portion 4100. The second coupling portion 4300 may be disposed in the rotation receiving portion 1500 of the housing 1000 along with the axial link 6500 to be described below, and may be disposed in a space formed in the first main portion 1100 of the housing 1000 along with the second main portion 4100. Accordingly, the second coupling portion 4300 may be moved along the axial link 6500 in the rotation receiving portion 1500 of the housing 1000, and may rotate the second main portion 4100 by the movement of the axial link 6500. That is, the second coupling portion 4300 may be a center of rotation of the air curtain 4000.

Referring to FIGS. 2 and 3, and FIG. 7 to be described below, the actuator 5000 may be coupled to the housing 1000. More specifically, the actuator 5000 may be coupled to the second support 1300 of the housing 1000. The actuator 5000 may be connected to an external power supply device (not shown) and may receive power from the external power supply device. Accordingly, the actuator 5000 may generate power to rotate the air curtain 4000.

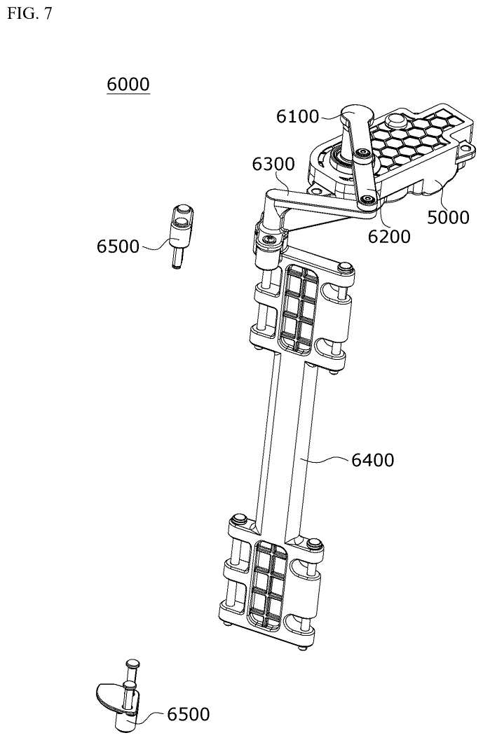

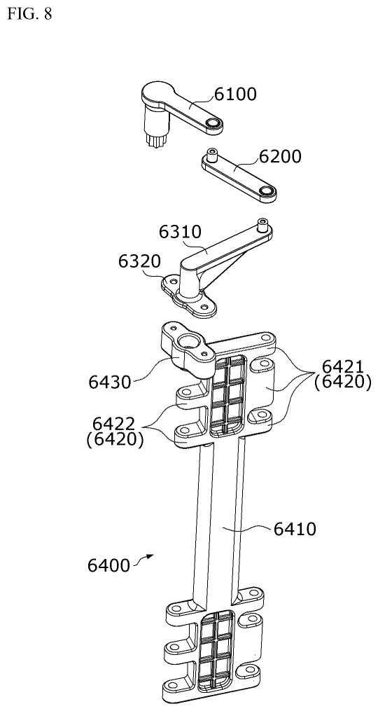

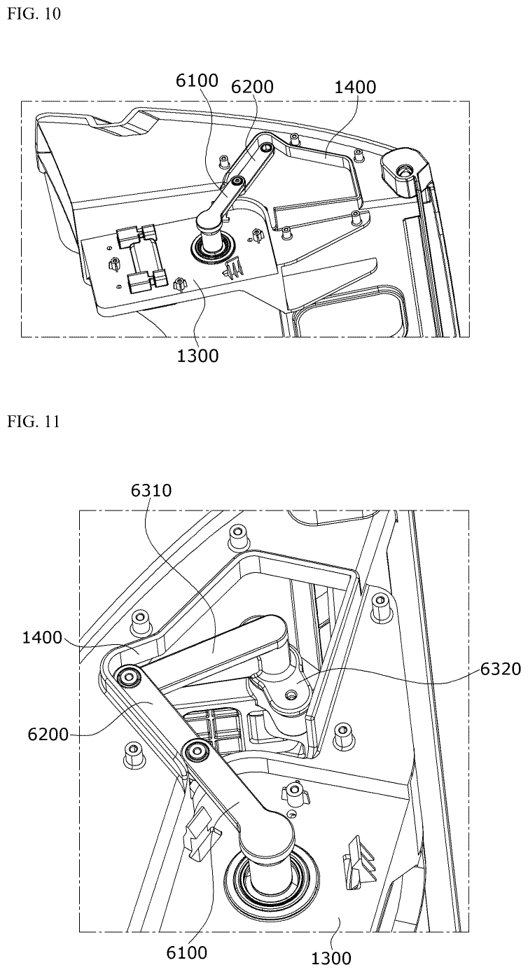

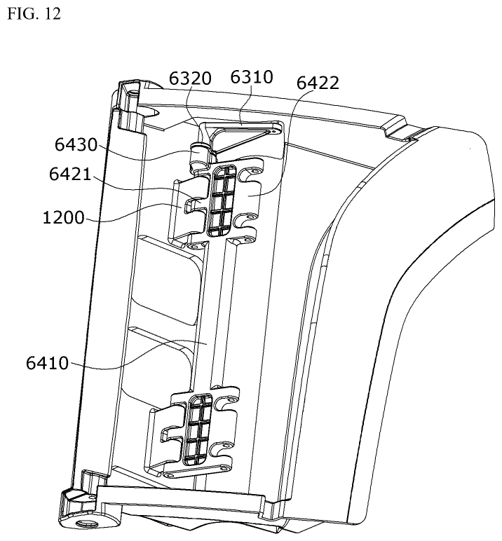

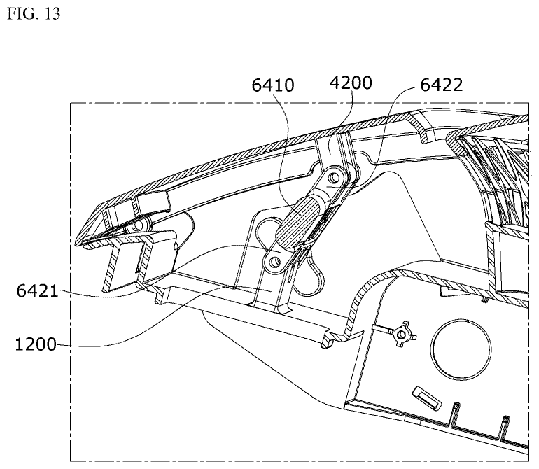

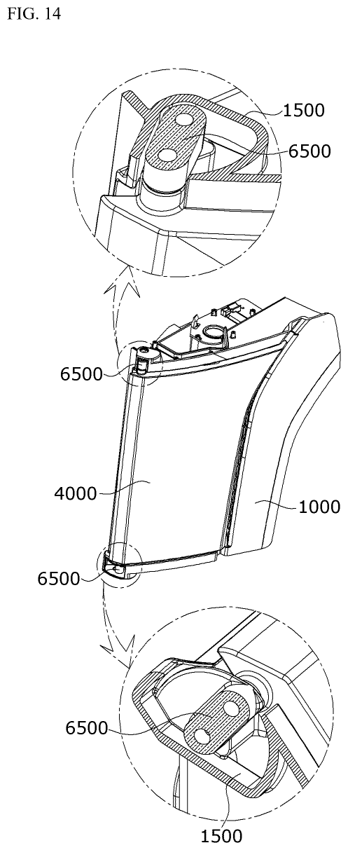

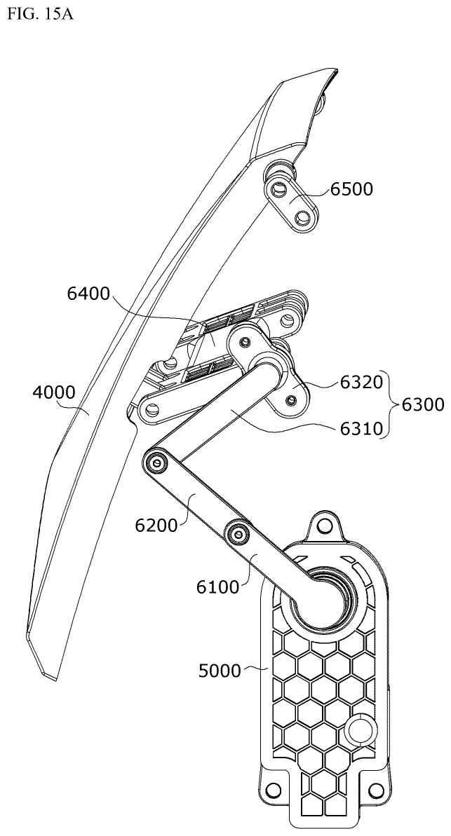

FIG. 7 is a perspective view of the link assembly, FIG. 8 is an exploded perspective view of the link assembly excluding the axial link, FIG. 9A is a view showing a state in which the actuator is disposed in the housing, FIG. 9B is a view showing a state in which the power transmission link is coupled to the actuator coupled to the housing, FIG. 10 is a view showing a state in which a first connecting link is coupled to the power transmission link, FIG. 11 is a view showing a state in which a second connecting link is coupled to the first connecting link, FIG. 12 is a view showing a state in which the curtain link is coupled to the housing, FIG. 13 is a view showing a state in which the housing and the air curtain are coupled to the power transmission link, and FIG. 14 is a view showing a state in which the axial link is disposed in the rotation receiving portion of the housing.

Referring to FIGS. 3, 7, and 8, the link assembly 6000 is connected to the housing 1000, the air curtain 4000, and the actuator 5000, and may pull the air curtain 4000 toward the actuator 5000 so that the air curtain 4000 exposes the inflow region 1140 formed in the housing 1000. The link assembly 6000 may include the power transmission link 6100, a first connecting link 6200, a second connecting link 6300, the curtain link 6400, and the axial link 6500.

Referring to FIG. 3 and FIGS. 7 to 9B, the power transmission link 6100 may be connected to the actuator 5000. More specifically, the power transmission link 6100 may pass through a hole formed in the second support 1300 of the housing 1000. The power transmission link 6100 passing through the hole formed in the second support 1300 of the housing 1000 may be coupled to the actuator 5000. Accordingly, the power transmission link 6100 may be rotated by power generated from the actuator 5000. Further, the power transmission link 6100 may be disposed in the first cover 2000 coupled to the second support 1300 of the housing 1000. Accordingly, the power transmission link 6100 may rotate in the first cover 2000.

Referring to FIGS. 7, 8, 10, and 11, the first connecting link 6200 may be rotatably coupled to the power transmission link 6100. Accordingly, the first connecting link 6200 may be rotated along the power transmission link 6100 rotated by power generated from the actuator 5000. Further, the first connecting link 6200 may be coupled to the second connecting link 6300. Accordingly, the first connecting link 6200 may pull the second connecting link 6300 toward the actuator 5000 simultaneously while being rotated by the power transmission link 6100.

The second connecting link 6300 may be fixed to the curtain link 6400 to connect the first connecting link 6200 and the curtain link 6400. The second connecting link 6300 may be composed of a combination of a “¬”-shaped main coupling portion 6310 and a sub-coupling portion 6320 disposed on one side of the main coupling portion 6310 and having a shape corresponding to a shape of the second coupling portion 4300 of the curtain link 6400 to be described below.

Accordingly, the second connecting link 6300 may connect the first connecting link 6200 and the curtain link 6400 spaced apart from each other along the height direction. Further, a rib for reinforcing the rigidity of the main coupling portion 6310 may be disposed on the main coupling portion 6310. Since the second connecting link 6300 is fixed to the curtain link 6400 through a coupling member, when the second connecting link 6300 is rotated, the curtain link 6400 may be rotated in a state of being fixed to the second connecting link 6300.

Referring to FIGS. 7, 8, 12, and 13, the curtain link 6400 may connect the housing 1000 and the air curtain 4000. More specifically, the curtain link 6400 may rotate the air curtain 4000 while being rotated along the second connecting link 6300 rotated in conjunction with the movement of the first connecting link 6200. The curtain link 6400 may include a third main portion 6410, a fourth support 6420, and a fifth support 6430.

The third main portion 6410 may be a rectangular parallelepiped with rounded corners. The third main portion 6410 may be disposed along the height direction. The third main portion 6410 may support the fourth support 6420 and the fifth support 6430.

The fourth support 6420 may protrude from the third main portion 6410. The fourth support 6420 may be disposed on both end portions of the third main portion 6410 in the width direction. A plurality of fourth supports 6420 may be provided, and the plurality of fourth supports 6420 may be disposed spaced apart from each other along the height direction. As shown in FIG. 13, the plurality of fourth supports 6420 disposed along the height direction may form a space which rotatably accommodates the first support 1200 of the housing 1000 and the first coupling portion 4200 of the air curtain 4000.

In this case, the fourth support 6420 may be rotatably coupled to the first support 1200 of the housing 1000 through a coupling member. Further, the fourth support 6420 may rotatably fix the first coupling portion 4200 of the air curtain 4000 through a coupling member. To this end, the fourth support 6420 may include a housing-side support 6421 coupled to the first support 1200 of the housing 1000 and an air curtain-side support 6422 coupled to the first coupling portion 4200 of the air curtain 4000. Accordingly, the curtain link 6400 may be rotated along the second connecting link 6300 in a state of being supported on the housing 1000 through the fourth support 6420, and may rotate the air curtain 4000 while pulling the air curtain 4000.

The fifth support 6430 may be disposed on the fourth support 6420 disposed at the top in the height direction among the fourth supports 6420. The fifth support 6430 may be coupled to the sub-coupling portion 6320 of the second connecting link 6300 to support the sub-coupling portion 6320. In this case, the fifth support 6430 may be fixed to the sub-coupling portion 6320 of the second connecting link 6300 through a coupling member such as a bolt or the like. The fifth support 6430 may rotate the fourth support 6420 and the third main portion 6410 in conjunction with the rotation of the second connecting link 6300. The fifth support 6430 may have a shape corresponding to the sub-coupling portion of the fourth support 6420.

Referring to FIGS. 2 and 14, the axial link 6500 may be coupled to the air curtain 4000. The axial link 6500 may be coupled to the air curtain 4000 and rotatably disposed in the rotation receiving portion 1500 of the housing 1000.

The axial link 6500 may be a center of rotation of the air curtain 4000. More specifically, the axial link 6500 may be rotatably fixed to the first main portion 1100 of the housing 1000 through another coupling member in a state of being coupled to the second coupling 4300 of the air curtain 4000 through a coupling member. Accordingly, the axial link 6500 has a fixed center of rotation, and has a movable center of rotation which rotates around the fixed center of rotation.

In this case, the axial link 6500 is rotated around the fixed center of rotation, and the air curtain 4000 coupled to the axial link 6500 is rotated along the movable center of rotation using the fixed center of rotation as the center of rotation. Finally, due to the above structure, the fixed center of rotation formed in the axial link 6500 may be the center of rotation of the air curtain 4000.

As shown in FIG. 14, the axial links 6500 may be disposed on end portions of the air curtain 4000. More specifically, the axial links 6500 may be disposed at both end portions of the second main portion 4100 of the air curtain 4000 in the height direction. That is, a plurality of axial links 6500 may be provided. The plurality of axial links 6500 disposed in the rotation receiving portion 1500 of the housing 1000 may prevent the deterioration of aesthetics that occurs when the air curtain 4000 is rotated compared to conventional axial links disposed in the center of the housing 1000 or air curtain 4000 along the height direction. Accordingly, a structure in which the axle links 6500 are disposed at both end portions of the air curtain 4000 in the height direction may prevent the deterioration of the design marketability of the vehicle.

Hereinafter, a process of opening the inflow region 1140 formed in the housing 1000 will be described.

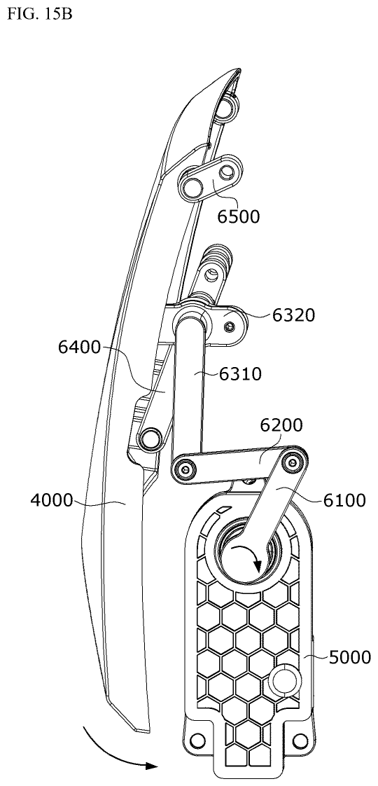

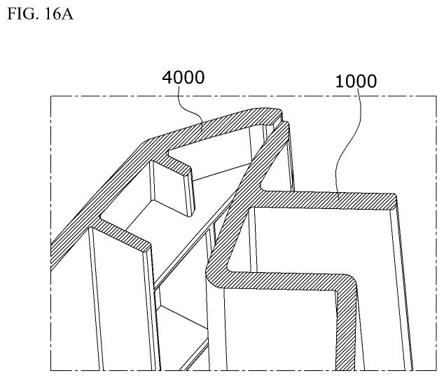

FIG. 15A is a view showing a state before the air curtain is rotated, and FIG. 15B is a view showing a state after the air curtain is rotated.

Referring to FIGS. 1 to 15B, and more specifically, referring to FIGS. 15A and 15B, a state in which the air curtain 4000 closes the inflow region 1140 of the housing 1000 when the vehicle is driven is a default state. In this state, when power is generated from the actuator 5000, the power transmission link 6100 coupled to the actuator 5000 is rotated. In this case, as in a process from FIG. 15A to FIG. 15B, the power transmission link 6100 is rotated clockwise.

When the power transmission link 6100 rotates, the power transmission link 6100 pulls the first connecting link 6200, and the first connecting link 6200 pulled by the power transmission link 6100 pulls the second connecting link 6300 while rotating. Accordingly, the second connecting link 6300 is rotated along the first connecting link 6200.

When the second connecting link 6300 rotates, the curtain link 6400 coupled to the second connecting link 6300 through the fifth support 6430 rotates. In this case, since the curtain link 6400 is fixedly coupled to the second connecting link 6300, the curtain link 6400 is rotated along the second connecting link 6300.

Further, since the curtain link 6400 rotatably supports the air curtain 4000, the curtain link 6400 rotated along the second connecting link 6300 may pull the air curtain 4000. Accordingly, the air curtain 4000 may rotate counterclockwise. In this case, the air curtain 4000 is rotated around the axial link 6500 of the link assembly 6000 as the center of rotation (the fixed center of rotation is the center of rotation). Accordingly, as shown in FIG. 15B, the air curtain 4000 which was closing the inflow region 1140 of the housing 1000 opens the inflow region 1140 of the housing 1000, and the driving wind passes through the inflow region 1140 and the guide portion 1600 formed in the housing 1000 and then heads toward the wheel W.

Thus, the air curtain device 1 according to one embodiment of the present disclosure may introduce the driving wind into the vehicle or block the driving wind according to a user's selection.

Hereinafter, the features of the air curtain device 1 will be described.

Referring to FIGS. 15A and 15B, the power transmission link 6100 may be rotated in a direction opposite to the rotating direction of the air curtain 4000. More specifically, the power transmission link 6100 pulls other links including the first connecting link 6200 of the link assembly 6000 toward the actuator 5000 while rotating in the direction opposite to the rotating direction of the air curtain 4000. This has an effect of pulling the first connecting link 6200 faster when the power transmission link 6100 rotates in the same direction as a rotating direction of the first connecting link 6200 than when the power transmission link 6100 rotates in a direction opposite to the first connecting link 6200.

Accordingly, the second connecting link 6300, the curtain link 6400, and the air curtain 4000 connected to the first connecting link 6200 operate faster compared to when the power transmission link 6100 rotates in the direction opposite to the first connecting link 6200, which may result in a faster response of the air curtain 4000 compared to a conventional air curtain device.

Accordingly, since the driving wind may move toward the wheel W faster compared to the conventional air curtain device due to the fast response of the air curtain 4000, the air curtain device 1 of the present disclosure may have an effect that helps enhance aerodynamics.

Referring to FIGS. 15A and 15B, a radius of rotation of the curtain link 6400 and a radius of rotation of the axle link 6500 may be different. More specifically, an interval between the hole formed in the housing-side support 6421 of the curtain link 6400 and the hole formed in the air curtain-side support 6422 is formed longer than an interval between the two holes in the axial link 6500.

With this structure, when the air curtain 4000 rotates, the air curtain 4000 is pulled by the curtain link 6400 while rotating around the fixed center of rotation of the axial link 6500. This may mean that a portion of the air curtain 4000 not coupled to the axial link 6500 moves more than a portion of the air curtain 4000 coupled to the axial link 6500, and thus a radius of operation of the air curtain 4000 decreases compared to when the curtain link 6400 and the axial link 6500 have the same radius of rotation.

Accordingly, when the air curtain 4000 closes the inflow region 1140 formed in the housing 1000, since a phenomenon of the air curtain 4000 protruding outward from the outer surface of the housing 1000 is prevented, an effect in that the deterioration of a design is prevented through the air curtain device 1 may be acquired.

Referring to FIGS. 15A and 15B, when the air curtain 4000 closes the inflow region 1140 formed in the housing 1000, the first connecting link 6200 may be disposed parallel to the power transmission link 6100. Accordingly, the first connecting link 6200 may generate a supporting force which prevents the rotation of the power transmission link 6100. Accordingly, when pressure is applied to the air curtain 4000 by the driving wind, since the rotation of the power transmission link 6100 is prevented, a phenomenon of the air curtain 4000 forcibly opening the inflow region 1140 of the housing 1000 may be prevented. Further, since the rotation of the power transmission link 6100 is prevented, a phenomenon of the internal components of the actuator 5000 connected to the power transmission link 6100 being forcibly operated and damaged may be prevented.

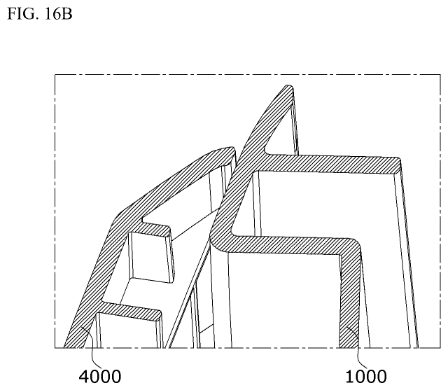

FIGS. 16A and 16B is a view showing a state in which a portion of the air curtain moves.

Referring to FIGS. 16A and 16B, when the air curtain 4000 rotates, the air curtain 4000 may be moved so that an interval with the housing 1000 does not increase. More specifically, as shown in a process from 16A to 16B, the rotating air curtain 4000 moves along a portion of the first main portion 1100 of the housing 1000. That is, unlike a hinge structure, since the air curtain 4000 does not rotate from the first main portion 1100 of the housing 1000, the deterioration of the design aesthetics of the vehicle does not occur when air curtain 4000 rotates, and thus the deterioration of a design of a front of the vehicle may be prevented.

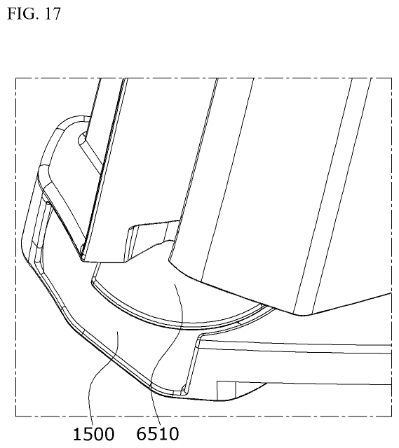

FIG. 17 is a view showing a state in which a covering portion of the axial link covers a portion of the rotation receiving portion of the housing.

Referring to FIG. 17, the axial link 6500 may include a covering portion 6510. The covering portion 6510 is disposed on an outer surface of the axial link 6500 and may have a fan shape. The covering portion 6510 may be rotatably disposed in the rotation receiving portion 1500 of the housing 1000.

The axial link 6500 may cover an open region of the rotation receiving portion 1500 of the housing 1000. More specifically, as shown in FIG. 17, when the air curtain 4000 is rotated to open the inflow region 1140 of the housing 1000, the covering portion 6510 may be rotated to close a region of the rotation receiving portion 1500. Accordingly, since the inside of the rotation receiving portion 1500 is closed and thus is not visible due to the covering portion 6510, the deterioration of the design of the front of the vehicle may be prevented.

Thus, the air curtain device 1 according to one embodiment of the present disclosure may serve to improve the design of the front of the vehicle.

According to one embodiment of the present disclosure, since an air curtain is rotated in a direction from a side of the vehicle toward a center, a design image of the air curtain disposed on the side of the vehicle can be prevented from significantly changing. Accordingly, since the deterioration of the visual design of a vehicle is prevented, the deterioration of design marketability can be prevented.

Although the above has been described with reference to the embodiments of the present disclosure, it should be understood that those skilled in the art may variously modify and change the present disclosure within a range not departing from the spirit and scope of the present disclosure disclosed in the claims to be described below. Further, it should be interpreted that differences related to the modifications and changes are included the scope of the present disclosure as defined by the appended claims.

What is claimed is:

1. An air curtain device disposed in front of a wheel of a vehicle, comprising:
a housing including an inflow region that allows a driving wind to pass therethrough;
an air curtain rotatably disposed in the housing;
an actuator that is coupled to the housing and generates power that rotates the air curtain; and
a link assembly that is connected to the housing, the air curtain, and the actuator, and pulls the air curtain toward the actuator so that the air curtain exposes the inflow region of the housing.

2. The air curtain device of claim 1, wherein the link assembly includes a power transmission link connected to the actuator, and
the power transmission link rotates in a direction opposite to a rotating direction of the air curtain.

3. The air curtain device of claim 2, wherein the link assembly includes:
a curtain link that connects the housing and the air curtain;
a first connecting link rotatably coupled to the power transmission link; and
a second connecting link fixed to the curtain link to connect the first connecting link and the curtain link.

4. The air curtain device of claim 3, wherein the first connecting link is disposed parallel to the power transmission link when the air curtain closes the inflow region of the housing.

5. The air curtain device of claim 3, wherein the link assembly includes an axial link that is coupled to the air curtain and serves as a center of rotation of the air curtain, and
the housing includes a rotation receiving portion that rotatably receives the axial link therein.

6. The air curtain device of claim 5, wherein the axial link covers an open region of the rotation receiving portion of the housing.

7. The air curtain device of claim 5, wherein a radius of rotation of the curtain link and a radius of rotation of the axial link are different.

8. The air curtain device of claim 5, wherein the axial link is disposed at an end portion of the air curtain.
